(19) United States
(12) Patent Application Publication
(10) Pub. No.: US 2002/0077840 A1
(43) Pub. Date: Jun. 20, 2002

(54) Business support and control system and method

(76) Inventor: Alan R. Shealy, Roswell, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 09/828,579

(22) Filed: Apr. 2, 2001

Related U.S. Application Data
(60) Provisional application No. 60/193,827, filed on Mar. 31, 2000.
(60) Provisional application No. 60/193,680, filed on Mar. 31, 2000.

(51) Int. Cl. G06F 17/60

(52) U.S. Cl. 705/1

(57) ABSTRACT

The present invention provides a system and method for providing for future rate changes in a billing system. In architecture, the system includes an identifier that identifies that a future rate plan is to be changed, and a selector that enables a user to select the future rate plan desired. A processor implements the future rate change. The present invention can also be viewed as a method for providing for future rate changes in a billing system. The method operates by (1) identifying that a future rate plan is to be changed; (2) selecting the future rate plan desired; and (3) implementing the future rate change.

### CLAIM OF PRIORITY AND CROSS REFERENCE TO RELATED APPLICATIONS

This application claims the benefit of U.S. Provisional Patent Application entitled “Business Support and Control System,” filed Mar. 31, 2000 and having serial No. 60/193,827, and U.S. Provisional Patent Application entitled “Prepaid Service Interface System,” having ser. No. 60/193,680, both of the foregoing of which are now pending and are incorporated herein by reference.

### FIELD OF THE INVENTION

The present invention generally relates to computers and computer software, and more particularly, to a system and method for providing a business support and control system.

### DESCRIPTION OF RELATED ART

Customer care and billing systems are used in all firms that offer any customer goods or services, wherein the amount of consumption of goods or the length of utilization of services represent the main criteria for the prices that have to be paid by the consumer. In addition, such firms typically have a large number of customers (cf. power supply, gas supply, water supply, telecommunications) so that a large administration effort is required. Customer care and billing systems facilitate a simple administration of the enormous amount of customer data for such firms calculating the amounts of the bills to be charged relating to appropriate settings fixed in advance, as well as drawing up the bills themselves.

Recently, there have been vigorous changes in the telecommunication sector caused by the increasing development of new technologies (mobiles, WAP, etc.). As the market is open to virtually any competitor, potential subscribers are courted by many providers with ever-increasing intensity. Therefore, it is inevitable for the provider to give attention to such changes and rapidly adapt to the requirements of the market. While the number of subscribers and the technological possibilities are increasing, the demands on customer care and billing systems are increasing accordingly.

A customer care and billing system for the telecommunication market has a unique requirement for the ability to provide for a change in calling rate plans that are to become effective at a future date. Currently, any changes in the rate plan (a tariff model) performed within a business support and control system becomes effective immediately. Additionally, the requirement exists for business support and control systems to provide for the ability to change a rate plan that becomes effective on the next billing cycle. Changing the rate plan after the next billing cycle prevents a prorated charge from appearing on the customer's bill. Often, prorated charges confuse customers and lead to calls to the network providers call center.

Thus, a heretofore-unaddressed need exists in the industry to address the aforementioned and/or other deficiencies and inadequacies.

### SUMMARY OF THE INVENTION

The present invention provides a system and method for providing for future rate changes in a billing system. Briefly described, in architecture, the system of the preferred embodiment can be implemented as follows. The system includes an identifier that identifies that a future rate plan is to be changed, and a selector that enables a user to select the future rate plan desired. A processor then implements the future rate change.

The present invention can also be viewed as a method for providing for future rate changes in a billing system. In this regard, the preferred method can be broadly summarized by the following steps: (1) identifying that a future rate plan is to be changed; (2) selecting the future rate plan desired; and (3) implementing the future rate change.

Other features and advantages of the present invention will become apparent to one with skill in the art upon examination of the following drawings and detailed description. It is intended that all such additional features and advantages be included herein within the scope of the present invention.

### BRIEF DESCRIPTION OF THE DRAWINGS

The accompanying drawings incorporated in and forming a part of the specification illustrate several aspects of the present invention, and together with the description, serve to explain the principles of the invention. Moreover, in the drawings, like reference numerals designate corresponding parts throughout the several views. In the drawings:

FIG. 1 is a block diagram illustrating an example of the architecture of the network in which the future rate changes system may be implemented.

FIG. 2 is a block diagram illustrating an example of the computer system utilizing the billing system 30, including the accounting, reporting, billing, record collection, and services and tariff modules of the present invention, including the future rate changes module of the present invention.

FIG. 3 is a block diagram illustrating the architecture of the billing system and its interaction with other components including the future rate changes system of the present invention.

FIG. 4 is a flow diagram illustrating an example of the processing flow of the future rate changes system of the present invention, as illustrated in FIGS. 2 and 3.

### DETAILED DESCRIPTION OF THE PREFERRED EMBODIMENT

Reference will now be made in detail to the description of the invention as illustrated in the drawings. While the invention will be described in connection with these drawings, there is no intent to limit it to the embodiment or embodiments disclosed therein. On the contrary, the intent is to cover all alternatives, modifications, and equivalents included within the spirit and scope of the invention as defined by the appended claims.

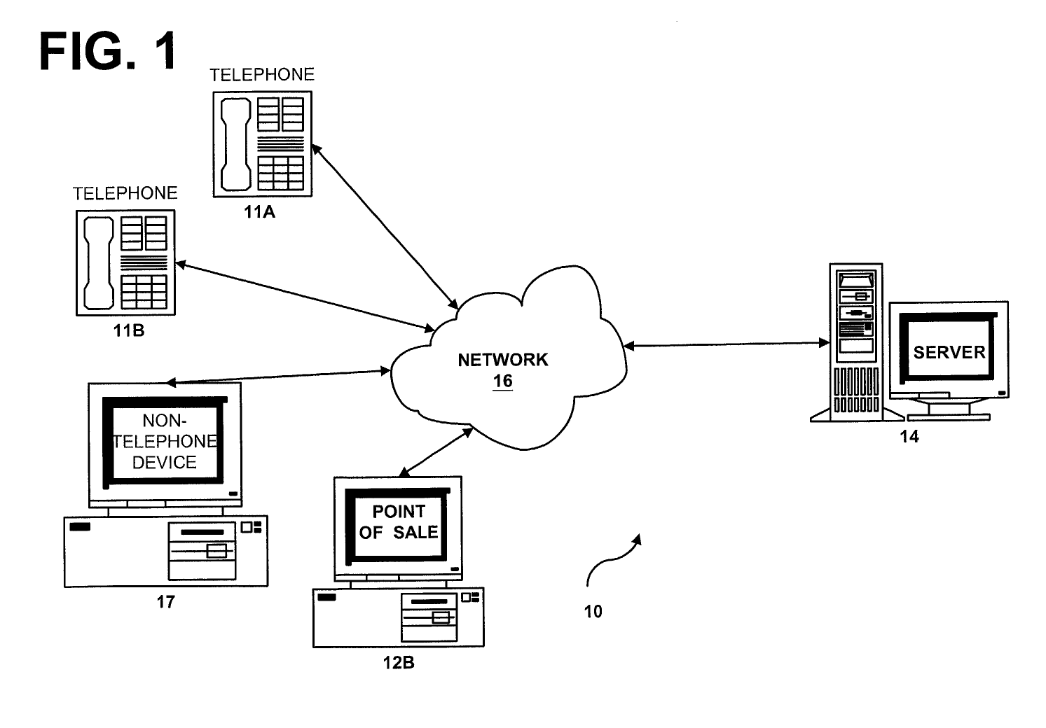

Referring now to the drawings, wherein like reference numerals designate corresponding parts throughout the drawings, FIG. 1 is a block diagram that portrays a diagram of a network that illustrates the flexibility, expandability, and platform independence in which the present billing system may be implemented. Referring to FIG. 1, a series of telephones (11a, 11b) and terminals (12 and 17) are connected to a server computer 14 via a network 16. The network 16 may be, for example, but is not limited to, a dial-in network, local area network (LAN), wide area network (WAN), public switched telephone network (PSTN), Intranet, Internet, Ethernet type networks, and the like. Telephones (11a, 11b) and terminals (12 and 17) may be located within a LAN, WAN, PSTN, Intranet, Internet, Ethernet type networks, or the like. It should be noted that the number of client computers and server computers may differ from the number presently illustrated. Further, it should also be noted that, that the preferred embodiment of the invention describes the functionality provided by a server computer 14.

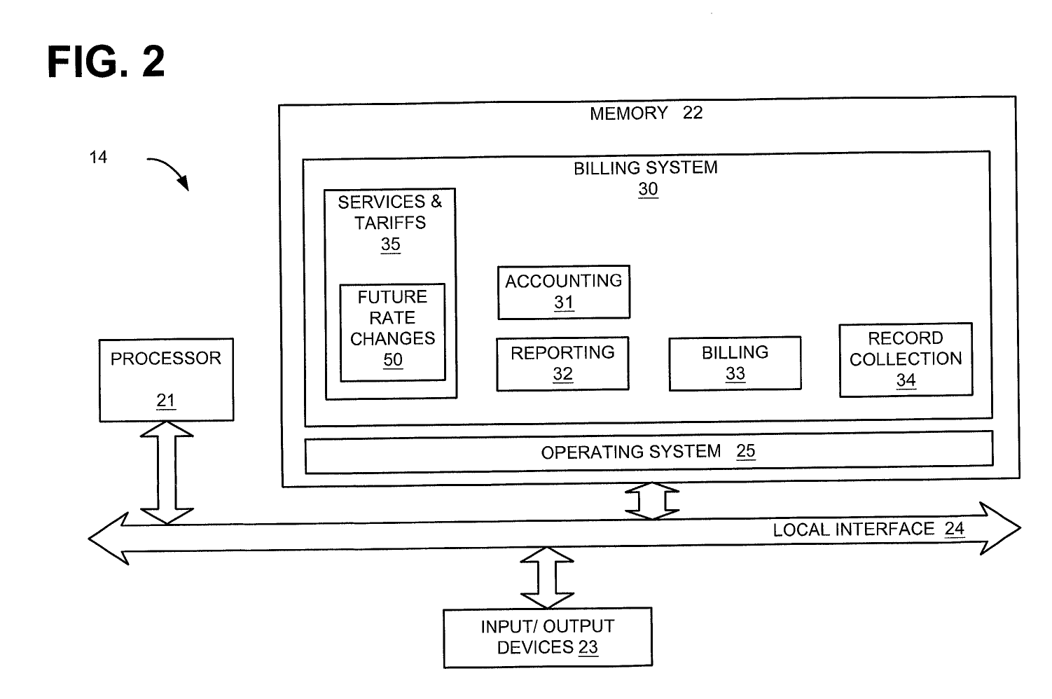

An example of a general-purpose computer that can implement the billing system of the present invention is shown in FIG. 2. The billing system, denoted by reference numeral 30, includes an accounting 31, reporting 32, billing 33, record collection 34 and service and tariffs 35 modules. Tariffs module 35 includes the future rate changes system 50 of the present invention. The billing system 30 of the invention can be implemented in software (e.g., firmware), hardware, or a combination thereof. In one embodiment, the billing system 30 is implemented in software, as an executable program, and is executed by a special or general purpose digital computer, such as a personal computer (PC, IBM-compatible, Apple-compatible, or otherwise), workstation, minicomputer, personal digital assistant (PDA) or mainframe computer.

Generally, in terms of hardware architecture, as shown in FIG. 2, the server computer 14 includes a processor 21, memory 22, and one or more input and/or output (I/O) devices 23 (or peripherals) that are communicatively coupled via a local interface 24. The local interface 24 can be, for example but not limited to, one or more buses or other wired or wireless connections, as is known in the art. The local interface 24 may have additional elements, which are omitted for simplicity, such as controllers, buffers (caches), drivers, repeaters, and receivers, to enable communications. Further, the local interface 24 may include address, control, and/or data connections to enable appropriate communications among the aforementioned components.

The processor 21 is a hardware device for executing software that can be stored in memory 22. The processor 21 can be virtually any custom made or commercially available processor, a central processing unit (CPU) or an auxiliary processor among several processors associated with the computer 14, and a semiconductor based microprocessor (in the form of a microchip) or a macroprocessor. Examples of suitable commercially available microprocessors are as follows: an 80x86 or Pentium series microprocessor from Intel Corporation, U.S.A., a PowerPC microprocessor from IBM, U.S.A., a Sparc microprocessor from Sun Microsystems, Inc, a PA-RISC series microprocessor from Hewlett-Packard Company, U.S.A., or a 68xxx series microprocessor from Motorola Corporation, U.S.A.

The memory 22 can include any one or combination of volatile memory elements (e.g., random access memory (RAM, such as DRAM, SRAM, etc.)) and nonvolatile memory elements (e.g., ROM, hard drive, tape, CDROM, etc.). Moreover, the memory 22 may incorporate electronic, magnetic, optical, and/or other types of storage media. Note that the memory 22 can have a distributed architecture, where various components are situated remote from one another, but can be accessed by the processor 21.

The software in memory 22 may include one or more separate programs, each of which comprises an ordered listing of executable instructions for implementing logical functions. In the example of FIG. 2, the software in the memory 22 includes the billing system 30 and a suitable operating system (O/S) 25.

A non-exhaustive list of examples of suitable commercially available operating systems 25 is as follows: a Windows operating system from Microsoft Corporation, U.S.A., a Netware operating system available from Novell, Inc., U.S.A., an operating system available from IBM, Inc., U.S.A., any LINUX operating system available from many vendors or a UNIX operating system, which is available for purchase from many vendors, such as Hewlett-Packard Company, U.S.A., Sun Microsystems, Inc. and AT&T Corporation, U.S.A. The operating system 25 essentially controls the execution of other computer programs, such as the billing system 30, and provides scheduling, input-output control, file and data management, memory management, and communication control and related services.

The billing system 30 may be a source program, executable program (object code), script, or any other entity comprising a set of instructions to be performed. When a source program, then the program is usually translated via a compiler, assembler, interpreter, or the like, which may or may not be included within the memory 22, so as to operate properly in connection with the O/S 25. Furthermore, the billing system 30 can be written as (a) an object oriented programming language, which has classes of data and methods, or (b) a procedure programming language, which has routines, subroutines, and/or functions, for example but not limited to, C, C++, Pascal, BASIC, FORTRAN, COBOL, Perl, Java, and Ada.

The I/O devices 23 may include input devices, for example but not limited to, a keyboard, mouse, scanner, microphone, etc. Furthermore, the I/O devices 23 may also include output devices, for example but not limited to, a printer, display, etc. Finally, the I/O devices 23 may further include devices that communicate both inputs and outputs, for instance but not limited to, a modulator/demodulator (modem, for accessing another device, system, or network), a radio frequency (RF) or other transceiver, a telephonic interface, a bridge, a router, etc.

If the server 14, is a PC, workstation, or the like, the software in the memory 22 may further include a basic input output system (BIOS) (omitted for simplicity). The BIOS is a set of essential software routines that initialize and test hardware at startup, start the O/S 25, and support the transfer of data among the hardware devices. The BIOS is stored in ROM so that the BIOS can be executed when the server 14 is activated.

When the server 14 is in operation, the processor 21 is configured to execute software stored within the memory 22, to communicate data to and from the memory 22, and to generally control operations of the computer 14 pursuant to the software. The billing system 30 and the O/S 25 are read, in whole or in part, by the processor 21, perhaps buffered within the processor 21, and then executed.

When the billing system 30 is implemented in software, as is shown in FIG. 2, it should be noted that the billing system 30 can be stored on virtually any computer readable medium for use by or in connection with any computer related system or method. In the context of this document, a computer readable medium is an electronic, magnetic, optical, or other physical device or means that can contain or store a computer program for use by or in connection with a computer related system or method. The billing system 30 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the billing system 30 is implemented in hardware, the billing system 30 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

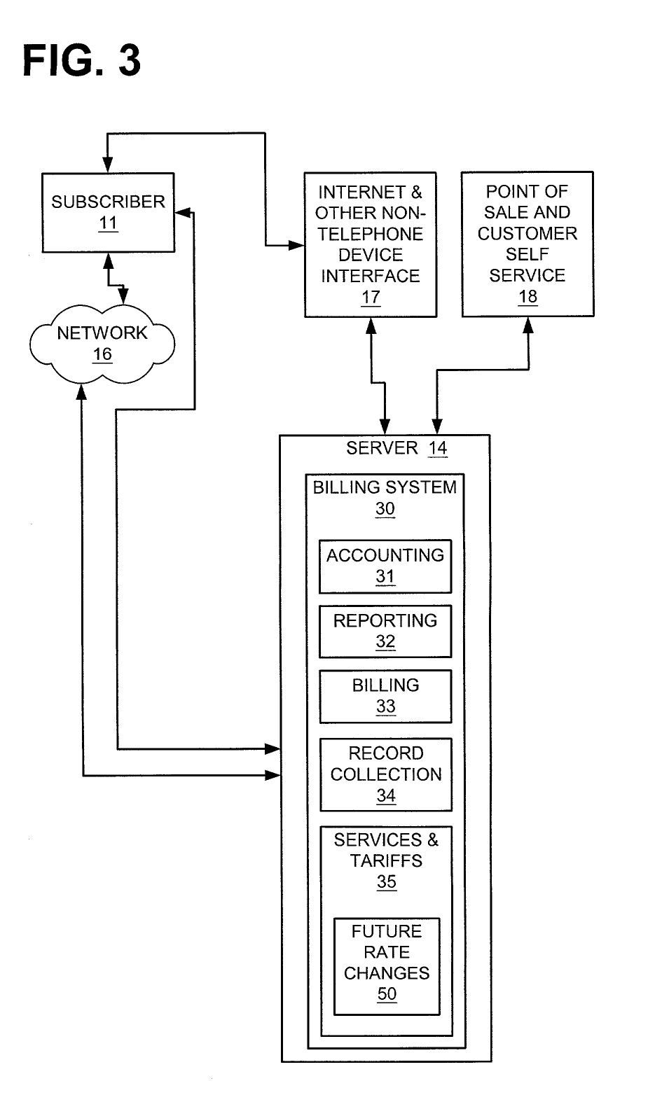

FIG. 3 is a data flow diagram illustrating an example of the process flow of the billing system 30 including the future rate changes system 50 of the present invention. The billing system 30 includes an accounting 31, reporting 32, billing 33, record collection 34, and a service and tariffs 35 modules. The service and tariffs module 35 includes the future rate changes system 50 of the present invention.

The future rate changes system 50 provides the ability for a change in billing rate plans to become effective at some future date. Additionally, there is the ability to provide for a change in rate plan to become effective immediately, at some preselected time, or on the next billing cycle run. Changing the rate plan to be effective on the next billing cycle prevents the prorating of services from appearing on a customer's bill, which could confuse the customer and lead to consumer complaints. The future rate changes system 50 provides for the ability to change a single rate plan, and mass rate plan changes. In the event that the rate plan changes are for a single customer, the future rate changes system 50 of the present invention allows for either the current date to be the effective change date or for the customer to select some future date to be the effective contract change date. The future rate changes module system 50 also provides for fast rate changes to be effective for the next billing cycle date.

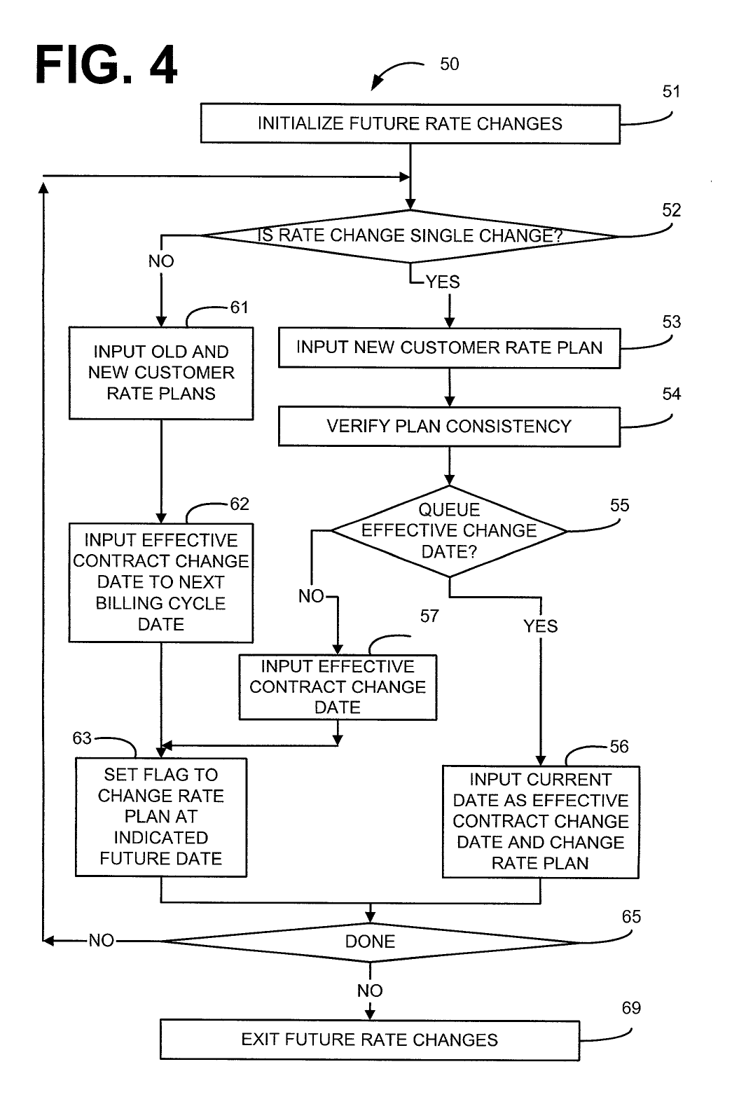

Illustrated in FIG. 4 is a process flow of the future rate changes system 50 of the present invention. First, the future rate changes system 50 is initialized at step 51. At step 52, the future rate changes system 50 then determines whether the rate changes a single rate change. If it is determined at step 52 that this rate change is a single rate, then the new customer rate plan is input at step 53 and verified at step 54. The future rate changes system 50 then determines whether the contract effective date is to be queued (step 55). If it is determined that the contract effective date is to be queued, then the future rate changes system 50 inputs the current data, the effective contract date, and changes the rate plan at step 56, and skips to step 65.

However, if it is determined at step 55 that the contract effective date is not to be queued, then the future rate changes system 50 requests input of the effective contract change data at step 57. After accepting input of the effective contract change date, the future rate changes system 50 then proceeds to step 63.

However, if it is determined at step 52 that the rate change is not a single rate change, then the future rate changes system 50 proceeds to step 61 to accept input of the old and new customer rate plans. At step 62, the effective contract change date of the next billing cycle date is input at step 63. At step 63, the future rate changes system 50 then sends the flag to the change rate date plan at the indicated future date and proceeds to step 65.

At step 65, the future rate changes system 50 then determines whether there are more future rate changes to be effective. If it is determined at step 65 that there are more future rate changes to be implemented, the future rate changes system 50 then returns to repeat steps 52 through 65. However, if it is determined at step 65 that there are no more future rate changes to be implemented, then the future rate changes system 50 exits at step 69.

The foregoing description has been presented for purposes of illustration and description. It is not intended to be exhaustive or to limit the invention to the precise forms disclosed. Modifications or variations are possible in light of the above teachings.

The embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly and legally entitled.

What is claimed is:

1. A system for providing for future rate changes in a billing system, comprising:
means for identifying that a future rate plan is to be changed;
means for selecting the future rate plan desired; and
means for implementing the future rate change.

2. The system of claim 1, further comprising:
means for determining if the future rate change is a single plan change.

3. The system of claim 2, further comprising:
means for verifying that the future rate plan is consistent with an old rate plan if the future rate change is the single plan change.

4. The system of claim 3, further comprising:
means for selecting the effective date of the future rate plan.

5. The system of claim 4, further comprising:
means for selecting the first day of a next billing cycle if the future rate change is not a single plan change.

6. A method for providing for future rate changes in a billing system, said method comprising the steps of:
identifying that a future rate plan is to be changed;
selecting the future rate plan desired; and
implementing the future rate change.

7. The method of claim 6, further comprising the step of:
determining if the future rate change is a single plan change.

8. The method of claim 7, further comprising the step of:
verifying that the future rate plan is consistent with an old rate plan if the future rate change is the single plan change.

9. The method of claim 6, further comprising the step of:
selecting the effective date of the future rate plan.

10. The method of claim 6, further comprising the step of:
selecting the first day of a next billing cycle if the future rate change is not a single plan change.

11. A computer readable medium for providing for future rate changes in a billing system, comprising:
logic for identifying that a future rate plan is to be changed;
logic for selecting the future rate plan desired; and
logic for implementing the future rate change.

12. The computer readable medium of claim 11, further comprising:
logic for determining if the future rate change is a single plan change.

13. The computer readable medium of claim 12, further comprising:
logic for verifying that the future rate plan is consistent with an old rate plan if the future rate change is the single plan change.

14. The computer readable medium of claim 11, further comprising:
logic for selecting the effective date of the future rate plan.

15. The computer readable medium of claim 11, further comprising:
logic for selecting the first day of a next billing cycle if the future rate change is not a single plan change.

16. A system for providing for future rate changes in a billing system, comprising:
an identifier that identifies that a future rate plan is to be changed;
a selector that enables a user to select the future rate plan desired; and
a processor that implements the future rate change.

17. The system of claim 16, further comprising:
a determiner that determines if the future rate change is a single plan change.

18. The system of claim 17, further comprising:
a validator that validates that the future rate plan is consistent with an old rate plan if the future rate change is the single plan change.

19. The system of claim 16, wherein the selector is configured to enable a user to select the effective date of the future rate plan.

20. The system of claim 16, wherein the selector is configured to select the first day of a next billing cycle if the future rate change is not a single plan change.
